(19) United States
(12) Patent Application Publication
(10) Pub. No.: US 2019/0253580 A1
(43) Pub. Date: Aug. 15, 2019

(54) SYSTEM AND METHOD FOR AUGMENTED REALITY VIEWING FOR DOCUMENT PROCESSING DEVICES

(71) Applicants: Kabushiki Kaisha Toshiba, Minato-ku (JP); Toshiba TEC Kabushiki Kaisha, Shinagawa-ku (JP)

(72) Inventor: Marianne KODIMER, Huntington Beach, CA (US)

(21) Appl. No.: 15/893,032

(22) Filed: Feb. 9, 2018

(51) Int. Cl. H04N 1/32; H04N 1/00; G06T 19/00; H04W 4/02

(52) U.S. Cl. CPC H04N 1/32662; H04N 1/00307; H04N 1/00344; H04N 1/00037; H04N 1/00973; G06T 2219/004; G06T 19/003; H04N 1/00251; H04W 4/02; H04N 2201/0094; H04N 2201/3253; H04N 1/32122

(57) ABSTRACT

A system and method for augmented reality for office machines such as multifunction peripherals (MFPs) includes a processor and memory and a data interface. Multifunction peripheral data is stored and corresponds to locations of identified MFPs. Device location data corresponds to a location of a portable data device such as a smartphone or other portable digital device. Relative location of the MFPs and the portable data device is determined. An image overlay corresponding to a property of one or more MFPs is displayed on the portable data device.

### TECHNICAL FIELD

This application relates generally to augmented reality for electronic images associated with document processing devices. The application relates more particularly to providing multifunction peripheral device users, device administrators or device technicians with targeted information relative to the multifunction peripheral.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

MFPs are complex devices that touch on three classes of individuals. First are device users who rely on the MFP for printing, scanning, faxing, or any other user function provided by the device. A second class of individuals includes device administrators which may include someone who allocates user permissions or performs accounting for device usage. Administrators may also include individuals who perform routine maintenance, like stocking of consumables such as ink, toner or paper. The third class of individuals is service technicians who must periodically come on site to maintain, diagnose or repair devices. Each class has its own needs for device information.

A user may wish to know if ink, toner or paper is depleted to select an alternative MFP, replenish the consumable themselves or notify an administrator to do so. An administrator may further wish to know a page count for paper based document processing jobs. A service technician may wish to know a location of an MFP needing servicing, as well as error conditions associated with an MFP. It will be appreciated that some individuals may fill two or more of these roles.

### SUMMARY

In accordance with an example embodiment of the subject application, a system and method for augmented reality for office machines such as MFPs includes a processor and memory and a data interface. Multifunction peripheral data is stored and corresponds to a location of an identified MFP. Device location data corresponds to a location of a portable data device such as a smartphone or other portable digital device. Relative location of the MFP and the portable data device is determined. An image overlay corresponding to a property of the at least one MFP is displayed on the smartphone or other portable digital device.

### BRIEF DESCRIPTION OF THE DRAWINGS

Various embodiments will become better understood with regard to the following description, appended claims and accompanying drawings wherein:

FIG. 1 an example embodiment of an augmented reality document processing system;

FIG. 2 is an example embodiment of a networked digital device such as a multifunction peripheral;

FIG. 3 is an example embodiment of a digital data processing device such as a smartphone;

FIG. 4 is a flowchart of example operations for augmented reality viewing;

FIG. 5 is a first example embodiment of an augmented reality viewing;

FIG. 6 is a second example embodiment of an augmented reality viewing;

FIG. 7 is a third example embodiment of an augmented reality viewing;

FIG. 8 is a fourth example embodiment of an augmented reality viewing;

FIG. 9 is a fifth example embodiment of an augmented reality viewing; and

FIG. 10 is a sixth example embodiment of an augmented reality viewing.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

MFP device interaction by users, administrators and technicians is typically done via a user interface, such as a touchscreen display. Different interfaces may be supplied to different users based on their login credentials. A user may walk up to an MFP to make a copy, only to find that the device is out of paper or out of toner. An administrator may need to login with their administrative credentials to obtain access to page counts or user logs. A technician, frequently employed by a third party service provider, may be unfamiliar with a particular premises. The technician may also be unaware as to a location of a particular device on the premises, such as a device for which a service call was placed.

Proliferation of less expensive and more powerful portable data devices has led to widespread adoption. Such devices include smartphones, tablet computers, laptop computers, notebook computers, smart watches, intelligent eyewear, or other portable digital devices. A high percentage of workers in the workforce own one or more if these devices. Many carry their device, such as their smartphone, with them throughout the day. Modern portable data devices frequently include an embedded digital camera and a display, which may be a touchscreen display. Cameras can generate high resolution still images and video. Images are captured by the camera as directed by a user viewing the camera output on the device display.

Use of cameras associated with portable data devices has evolved beyond capture of still or video images. Cameras can serve as an input to function as a barcode or QR code reader. Cameras can also provide input for identification, such as via facial or other biometric recognition.

It is possible to determine a location of a portable data device by several different or complementary means. One such means relies on receipt of global positioning system (GPS) signals into a GPS input on the device from which its position can be calculated. Another means of location is via a cellular data connection. Rough location can be determined by knowing a location of a cell tower to which a cell phone is connected. Further refinement can be achieved by knowing a particular sector wherein the cell phone is connected. A cell tower may radiate three, 120° sectors in a horizontal, circular pattern. Still further refinement can be made by knowing a signal strength between the cell tower and the cell phone to approximate a distance between them. Still further refinement can be made by triangulation methods using multiple cell towers.

Other means for device location may rely on similar properties associated with connection to a wireless hotspot, a near field communication (NFC) signal, a Bluetooth signal or a beacon signal, such as with iBeacon technology from Apple, Inc. or Bluetooth low energy (LE) beacons.

Still further refinement of location can be accomplished using triangulation methods using multiple wireless connections with any of the afore-noted systems. Augmented Reality (AR) is a new technology used in conjunction with smart phone or device such as Glass eyewear to project digital information onto images of the physical world. Games such as Pokmon Go helped to popularize augmented reality games on mobile devices. Augmented reality is also used by Google, LLC, and others to provide services such as information about famous sites, statues, translations, and mapping information.

A reality application user interface is applied herein to office devices such as MFPs such wherein user, administrators or service technicians are provided with augmented reality information for any relevant information, such as device status, error information, troubleshooting information, consumable levels, and device health at a glance when viewing the actual physical device via camera feed or Glasses feed. Further, augmentation and visualizations can be differentiated by user role or user proximity to device allowing a customized experience. Visualizations are suitably interactive allowing user selection, such as using a touchscreen function on an augment display to invoke additional information, troubleshooting information, help, and tutorials that take into account the actual physical components of the device.

Suitable augmented reality aspects include:
Augmented user interface applied to MFP devices;
Visualization differentiation based on user role;
Visualization differentiation based on proximity;
Visualizations to identify error device among a set; or
AR visualizations that invoke actions when tapped from mobile interface.

A cloud-based service application contains device location based on Location GPS (or cell triangulation) in conjunction with metadata and state information including but not limited to the following:
Physical (customer) address;
Device identifier;
Error state (current error codes and function codes);
Dealer identifier;
IP Address;
Counter data; or
Last date of service.

A suitable augmented reality developers kit such as TANGO (developed by Google) or ARKit (developed by Apple iOS), allows for creation of a mobile applications that incorporate augmented reality visualizations as applied to the real world and detect surfaces, walls, and other objects. When trained to recognize MFPs, MFP components, or MFP location using machine learning and image matching or positioning, a system will recognize the MFP and suitably request associated cloud or device information including but not limited to consumable status, state, IP address, counter information, error codes, etc., as noted above.

User interaction with the mobile visualizations is implemented to access additional information. For example, when an error is shown (such as a paper jam), a superimposed status display suitably includes a clickable object to invoke troubleshooting information such as a video or step by step instruction on fixing the problem by recognizing and superimposing instruction on the actual component of interest. This helps service technicians as well as administrators in maintaining a healthy and working device.

Additionally, the type of information projected can depend on a user's role. For example, if a logged-in user is a service manager, they may see error code history. If the logged-in user is an on-premise administrator, they may see toner status, and if the logged-in user is a meter manager, they may see only meter data.

Visualizations are suitably invoked depending on relative proximity to device. As determined by beacon, GPS, or other directional device location system, visualizations can change depending on proximity. For example, if a portable data device is 20 feet away, an arrow or other alert would show only if state of device is not okay. If there is a device error, a visual indicator can be used to differentiate it from the rest of the devices without necessarily providing details.

Suitable identification of a device can also be made with indicia directly on the device, such as with written device name, such as “Printer 1,” or other visual identifier, such as a barcode or a quick response (QR) code. Device identification is suitably decoded from a code itself or from a server based or self-contained lookup table.

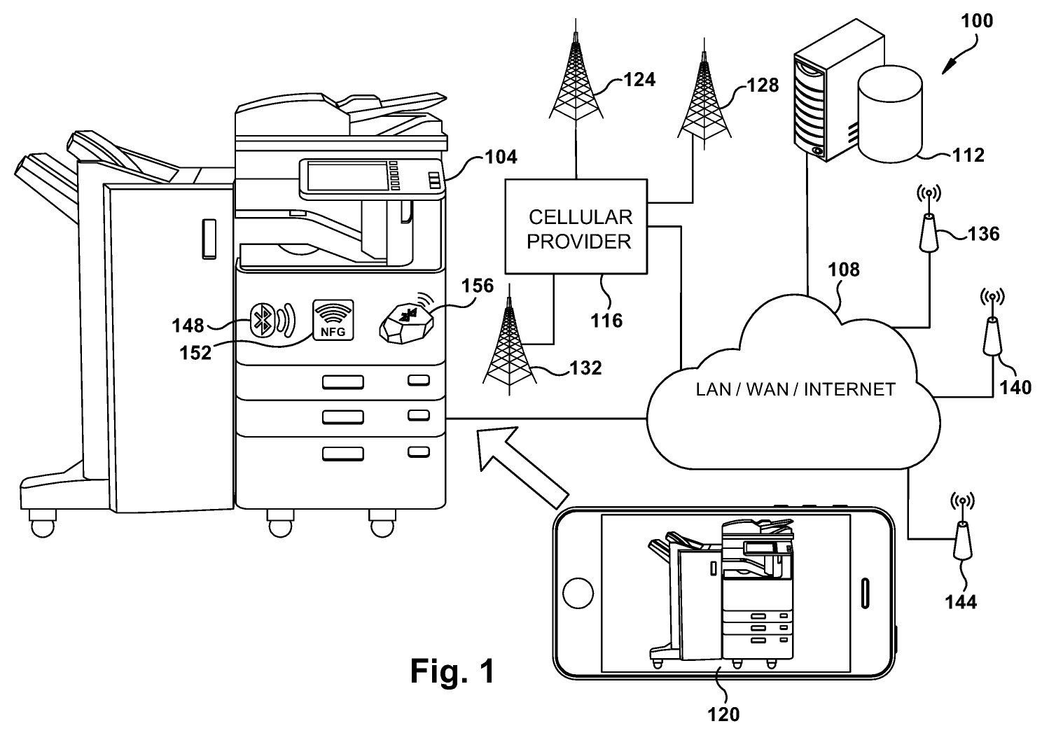

In accordance with the subject application, FIG. 1 illustrates an example embodiment of an augmented reality document processing system 100. MFP 104 is suitably provided with a network interface to network 108, suitably comprised of a local area network (LAN), a wide area network (LAN) which may comprise the Internet, or any suitable combination thereof. Also connected to network 108 are one or more servers, such as server 112. One or more wireless data providers, such as cellular provider 116 facilitate communication with a portable data device, such as smartphone 120. Cellular service is provided via cell towers, such as cell towers 124, 128 and 132. Location of smartphone 120 can be made in accordance with connection with one or more cell towers 124, 128 132 as noted above.

Wireless data connection with smartphone 120 is also suitably via one or more Wi-Fi hotspots, such as via hotspots 136, 140 and 144. Location of smartphone 120 can be made in accordance with connection with one or more hotspots 136, 140, or 144 as noted above.

MFP 104 is suitably provided with one or more wireless data exchange devices, such Bluetooth 148, NFC 152 or beacon 156 facilitating determination of proximity or distance between MFP 104 and smartphone 120. Interaction between devices in FIG. 1 provides for use of smartphone 120 in an augmented reality mode wherein a user directs the camera of their smartphone 120 to a location and information about one or more devices in the camera sight line is overlaid on one or more captured images. As will be detailed further below, determination of relative locations between objects such as MFP devices or MFP locations, such as buildings or position within a building, facilitates ease of locating, selecting or securing information for devices via augmented reality.

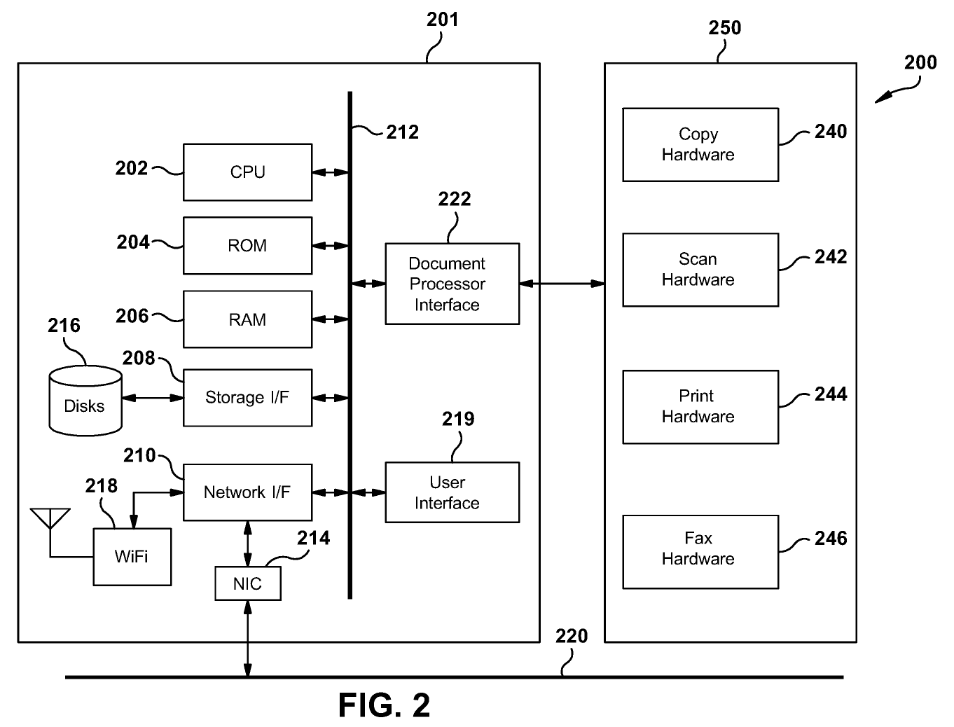

Turning now to FIG. 2 illustrated is an example embodiment of a networked digital device comprised of document rendering system 200 suitably comprised within an MFP, such as with MFP 104 of FIG. 1. It will be appreciated that an MFP includes an intelligent controller 201 which is itself a computer system. Thus, an MFP can itself function as a cloud server with the capabilities described herein. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with user interface 219 for interfacing with displays, keyboards, touchscreens, mice, trackballs and the like.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

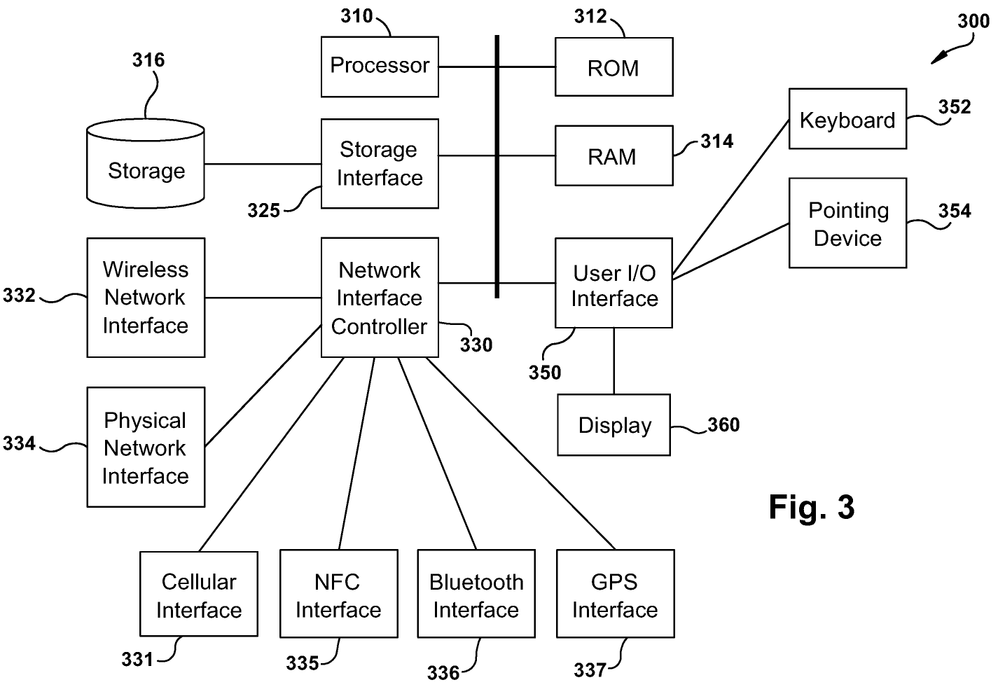

Turning now to FIG. 3, illustrated is an example embodiment of a digital data processing device 300 such as smartphone 120 of FIG. 1. Components of the data processing device 300 suitably include one or more processors, illustrated by processor 310, memory, suitably comprised of read-only memory 312 and random access memory 314, and bulk or other non-volatile storage 316, suitable connected via a storage interface 325. A network interface controller 330 suitably provides a gateway for data communication with other devices via wireless network interface 332 and physical network interface 334, as well as a cellular interface 231 such as when the digital device is a cell phone or tablet computer. Also included is NFC interface 335, Bluetooth interface 336 and GPS interface 337. A user input/output interface 350 suitably provides a gateway to devices such as keyboard 352, pointing device 354, and display 260, suitably comprised of a touch-screen display. It will be understood that the computational platform to realize the system as detailed further below is suitably implemented on any or all of devices as described above. A camera 356 provides for augmented reality interfacing as described herein.

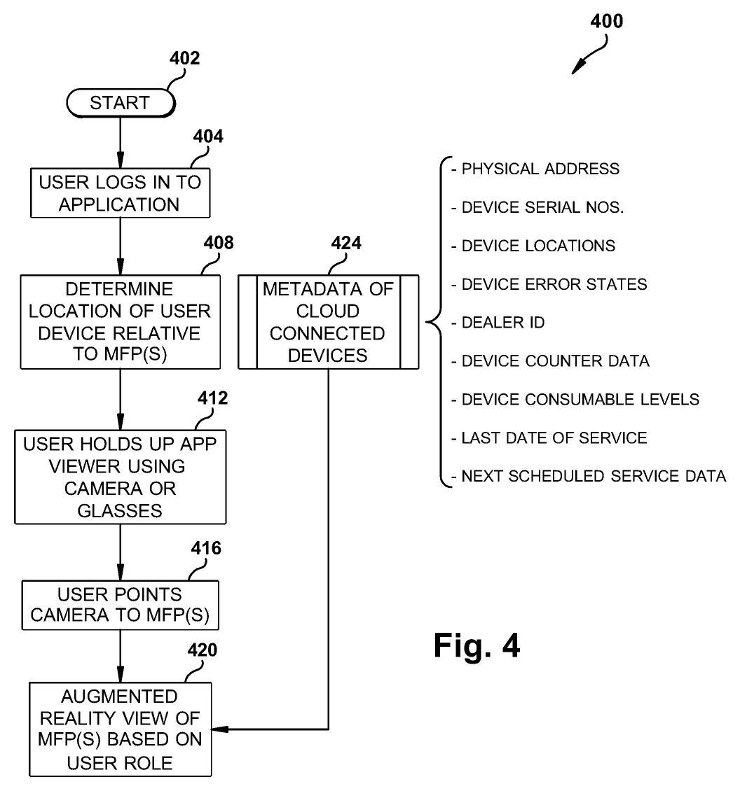

Referring now to FIG. 4, illustrated is a flowchart 400 of an example system for augmented reality viewing. The process commences at block 402 and a user logs into their augmented reality application at block 404. Relative locations between a user, a device or a device location are determined at block 408. A user holds up their smartphone camera, notebook camera, smart glasses camera or other portable data device at block 412 and points the camera of their device to one or more MFPs or one or more MFP locations at block 416. An augmented reality view is generated in the device view screen at block 420, suitably showing an augmented reality image of their surroundings in the direction in which they direct the camera of their device. Information 424 is suitably from the device itself, from a server in wireless data communication, or from one or more MFPs.

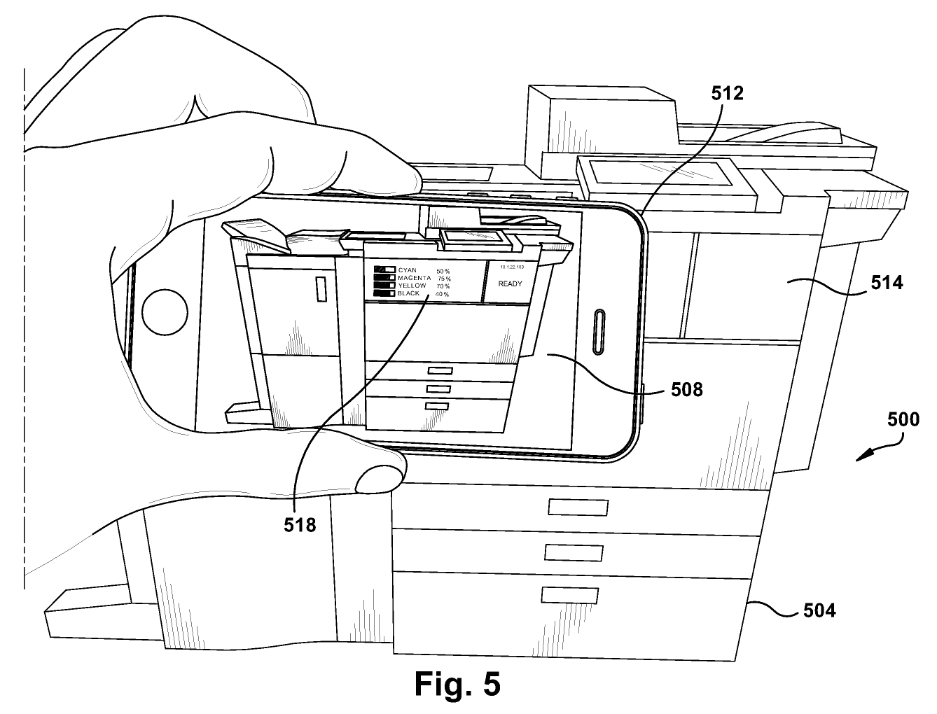

FIG. 5 is an example embodiment of an augmented reality session 500 wherein MFP 504 is viewed through a display 508 of smartphone 512. In the illustrated example, copier area 514 appears as a vacant area on the MFP 504 itself, while appearing with MFP information including device readiness and ink levels in augmented reality window 518.

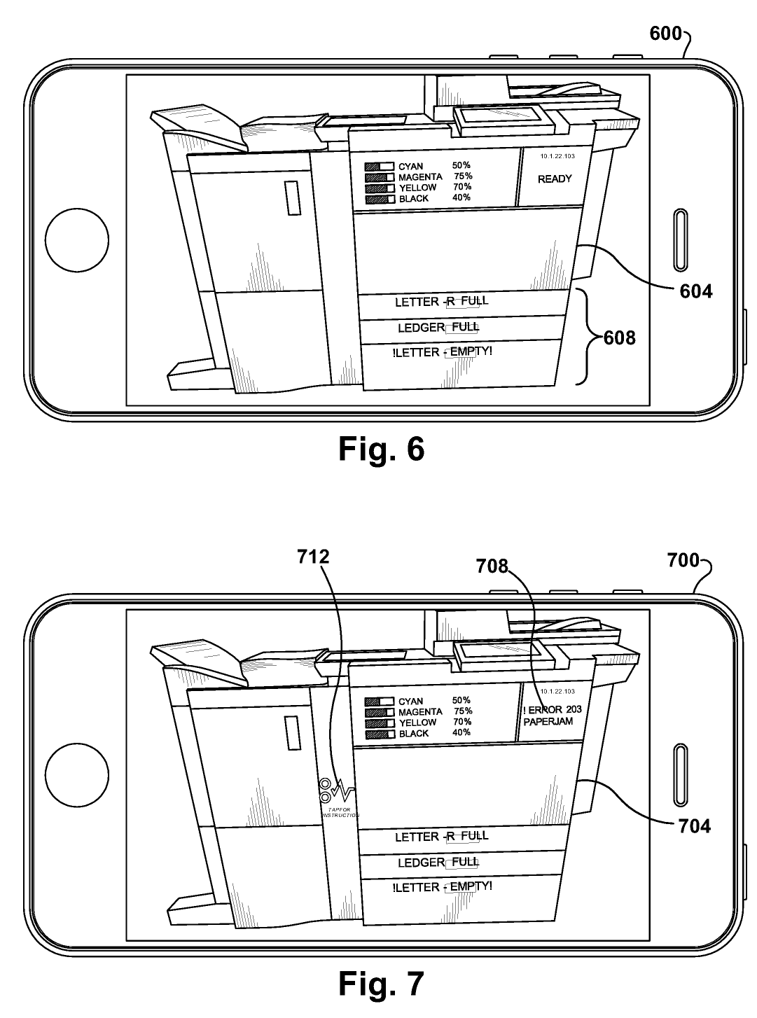

FIG. 6 is an example embodiment where smartphone 600 displays MFP 604 with augmented reality showing paper levels 608 superimposed over corresponding paper trays.

FIG. 7 is an example embodiment where smartphone 700 displays MFP 704 with device error conditions 708 and 712 regarding the presence of and location of a paper jam.

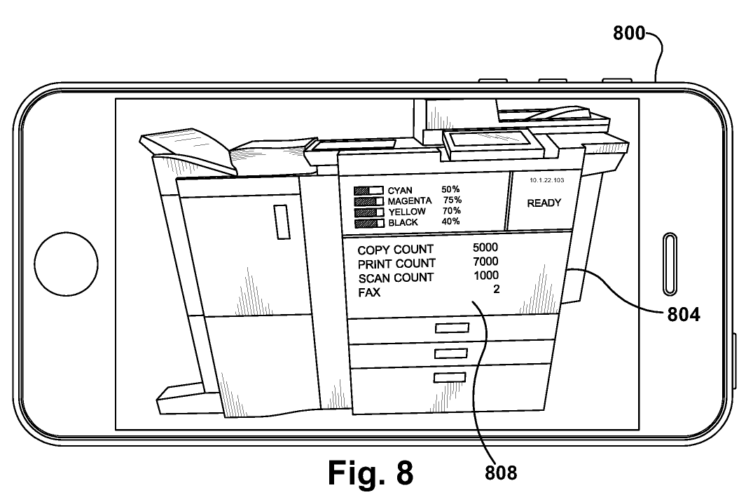

FIG. 8 is an example embodiment wherein smartphone 800 displays MFP 804 with device count information 808 including copy count, paper count, scan count and fax count information.

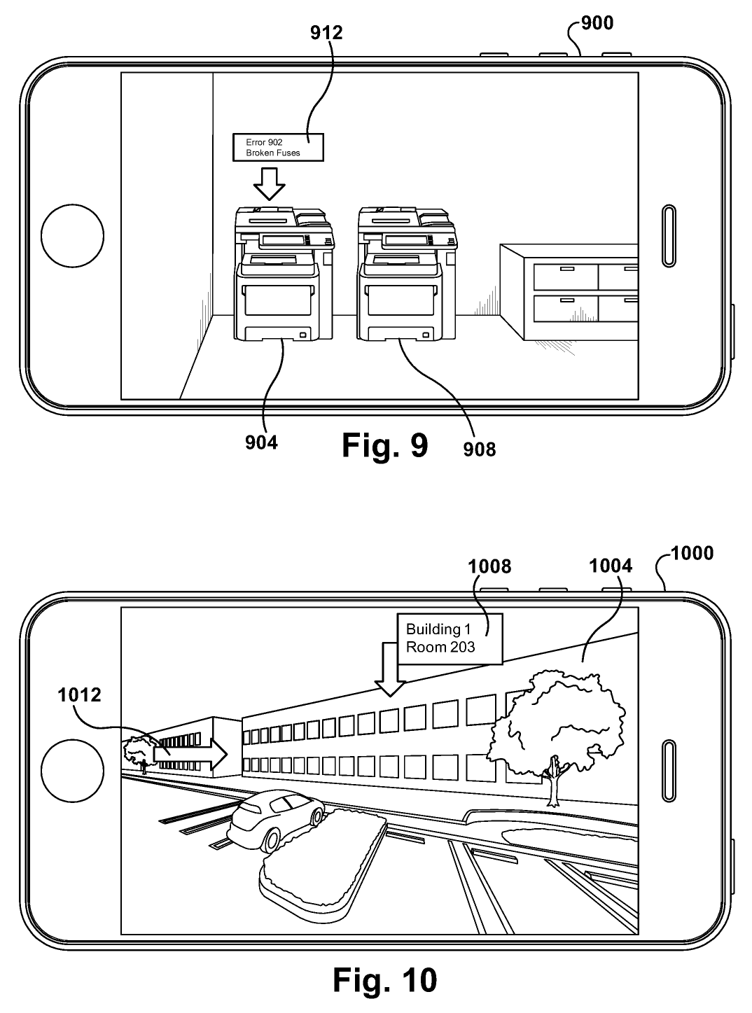

FIG. 9 is an example embodiment wherein multiple MFPs 904 and 908 are viewed simultaneously. In the example, a user is notified at 912 as to an error condition of a broken fuser on MFP 904.

FIG. 10 is an example embodiment wherein smartphone 1000 displays a business premises 1004. The building is identified at 1008 and a device location identified at 1012.

From the forgoing, it will be understood that augmented reality provides quick and updated information that can target a user's particular needs. Information is suitably updated or modified relative to distance to a device or devices. For example, multiple available devices can be shown at the same time from a distance, and differences can be revealed as a user gets closer. In the example, as a user gets closer, they may be informed as to a number of jobs ahead of their job on the devices or the different print speeds of the devices to allow a user to make their selection.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a data interface configured to communicate device location data corresponding to a location of a portable data device;
a display;
a camera configured to capture an image of a premises; and
a processor and associated memory,
the memory storing multifunction peripheral data corresponding to a location of an identified, out of sight multifunction peripheral (MFP) on the premises,
the processor configured to determine a relative location of the MFP and the portable data device,
the processor configured to generate the image of the premises on the display,
the processor configured to generate a directional indicator overlay on the image of the premises corresponding to the location of the MFP relative to the portable data device,
the processor configured to determine when the portable data device is proximate to the MFP,
the camera configured to capture an image of the MFP when the portable data device is proximate to the MFP,
the processor configured to generate the image of the MFP on the display,
the processor configured to display image overlay data corresponding to a property of the MFP on the image of the MFP.

2. The system of claim 1 further comprising:
a memory storing user identification data indicative of an identity or status of a user of the portable data device; and
wherein the processor is configured to select the property of the MFP in accordance with the user identification data.

3. The system of claim 1 wherein the indicator is comprised of graphical pointer.

4. The system of claim 1 wherein the property of the MFP includes data corresponding to a state of the MFP and wherein the image overlay data is comprised of an indicator of the state of the MFP.

5. The system of claim 1 wherein the state of the MFP includes a consumable level on the MFP.

6. The system of claim 1 wherein the state of the MFP includes an MFP identifier.

7. The system of claim 1 wherein the state of the MFP includes an error identifier.

8. The system of claim 1 wherein the processor is further configured to receive identification data corresponding to an identity associated with the portable data device, and
wherein the processor is further configured to selectively generate content comprising the image data in accordance with received identification data.

9. A method comprising:
enabling a digital camera on a portable data device;
determining a location of the portable data device relative to a multifunction peripheral (MFP);
communicating location data corresponding to the determined location to an associated server via a wireless data interface of the portable data device;
directing the digital camera toward a premises;
capturing an image of the premises;
displaying a capture image of the premises;
generating a directional indicator overlay on the displayed premises indicative of a location of the MFP on the premises;
moving the portable data device proximate the MFP;
directing the digital camera toward the MFP;
capturing an image associated with the MFP;
receiving image overlay data identifying a state of the MFP from the server; and
superimposing received image overlay data on the captured image.

10. The method of claim 9 further comprising selecting the image overlay data in accordance with an identity or status of an associated user.

11. The method of claim 10 further comprising superimposing the overlay data comprising a graphical pointer indicative of a location of the MFP within the building.

12. The method of claim 9 wherein the image associated with the MFP includes an image of an exterior of the MFP.

13. The method of claim 12 further comprising superimposing the overlay data comprising an MFP identifier.

14. The method of claim 12 further comprising superimposing the overlay data comprising an indicator of a condition of the MFP.

15. The method of 14 wherein the condition of the MFP includes a consumable level.

16. The method of claim 14 wherein the condition of the MFP includes an error indicator.

17. The method of claim 16 wherein the error indicator includes an indicator corresponding to a source of the error.

18. A multifunction peripheral (MFP) comprising:
an intelligent controller including a processor and associated memory;
a document processing engine operable in accordance with instructions received from the intelligent controller; and
a data interface,
wherein the processor is configured to receive identification data corresponding to an identity of a user associated with a portable data device,
wherein the intelligent controller is configured to monitor a plurality of conditions of the MFP,
wherein the processor is further configured to generate image data corresponding to a plurality of monitored states of the MFP, and
wherein the intelligent controller is further configured to communicate image data corresponding to a subset of the plurality of monitored states to the portable data device via the data interface determined accordance with the received identification data.

19. The MFP of claim 18 further comprising:
a sensor configured to detect a distance between the MFP and the portable data device,
wherein the processor is further configured to selectively communicate unique image data to the portable data device for each of a plurality of detected distances.

20. The MFP of claim 18 wherein the processor is further configured to receive an instruction from the portable data device responsive to the communicated image data.
